(19) United States
(12) Patent Application Publication
(10) Pub. No.: US 2006/0081099 A1
(43) Pub. Date: Apr. 20, 2006

(54) Guide rail system for hand held power tools like circular saws and routers

(76) Inventor: Tim Bradbury, Toronto (CA)

Correspondence Address: TIM BRADBURY, 239 GAINSBOROUGH RD., TORONTO, ON, M4L 3C7, CA

(21) Appl. No.: 10/967,679

(22) Filed: Oct. 18, 2004

(51) Int. Cl. B26D 1/00

(52) U.S. Cl. 83/13

(57) ABSTRACT

A guide rail system for hand held power tools like circular saws and routers comprising a rigid base component and adjustable guide components designed to lay directly on the material being worked and requiring no substructure of any kind, while accurately guiding and providing support to both sides of the power tool and reference to both sides of its cutting path.

### CROSS-REFERENCE TO RELATED APPLICATIONS

Not applicable

### FEDERALLY SPONSORED RESEARCH

Not applicable

### SEQUENCE LISTING OF PROGRAM

Not applicable

### BACKGROUND OF THE INVENTION

1. Field of the Invention

This invention relates to an improved guide system for hand held power tools, particularly circular saws and routers.

2. Prior Art

Woodworking has long needed an affordable, simple way to accurately work with large materials like 4′×8′ sheet goods. As more and more material comes in sheet sizes, it has become one of the biggest problems faced by woodworkers today.

There are dedicated tools, like panel saws and panel routers and large sliding table saws, for this application, but they are large, definitely not portable and well out of the price range of an average woodworker, many of whom must nonetheless deal with the aggravation of working with 4′×8′ sheets. Professionals working on job sites face the same problem—trying to work with 4′×8′ sheet goods with tools that don't do it at all well.

Many people, professionals included, lacking the large expensive equipment designed to do this work, fall back on the basic method of laying the sheet on some 2×4's on the floor or sawhorses, clamping on something as simple as a relatively straight board, and cutting the material with a circular saw. The results are predictably crude, but the reason so many still do this is that the circular saw is portable, light, and easy to work with, and the material itself doesn't have to be moved. With sheet goods like MDF and particle board weighing up to 100 lb. per sheet, not moving the material is something definitely to be preferred. So in many ways the ideal solution to this problem of trying to work 4′×8′ sheets and indeed any large awkward material, would be a circular saw guide that was portable, very accurate, required no or little adjustment to the saw itself, and was quick and easy to use.

There are no lack of circular saw (and router) guides on the market and in the patent database. They generally fall into two categories:

1. Clamp on straight edges—examples of these are U.S. Pat. Nos. 2,677,399, 3,586,077, and 2,708,465. These have the advantage of attaching to the material itself and being of sufficient rigidity and length to handle the 4′ and 8′ cuts required in sheet goods. These have limitations—a) they work to one side of the power tool only, requiring that either the tool be kept against the straight edge by the operator (with the potential for error if this isn't done properly), or b) they require that a secondary plate or other devise be attached to the power tool, and the secondary devise then tracks in a controlled way along the straight edge. Neither of these is a satisfying solution—the first is far to open to human error and the second requires that you have an awkward devise attached to something like your circular saw, which must be either attached and removed constantly, or left on and in practice often limit the use of the power tool to working with the straight edge and nothing else. Further, the additional plate must have a form of bearing connecting it to the straight edge, and this bearing is prone to play and wear. All long clamp on straight edges also have the usually ignored disadvantage of limiting the straightens of the cut to the inherent straightness of the straight edge itself. Most long clamp on straight edges also give no reference to where the power tool will cut.

2. Rail systems that attach to a substructure—examples of these are U.S. Pat. Nos. 3,368,594, 3,741,063 and 4,050,340. These systems are generally designed to allow both angle and straight cuts. These systems solve the problem of supporting the saw or router without an additional plate by using two rails, one on each side of the tools. However, they all require a substructure to attach the rails themselves to, which creates it own set of problems—the size and weight of a substructure large enough to handle 4′×8′ sheets is substantial, and the rigidity and accuracy of the rails themselves for these size of cuts brings you right back to the cost and size of a panel saw. The substructure, by nature, lies beneath the material and the tool cannot therefore work on top of the material alone, as many everyday applications require. In practice, these dual rail systems are limited in range—they are fine for doing crosscuts up to around 2′, but beyond this become too large and awkward. These designs in practical use have been generally supplanted by power mitre saws.

For example in U.S. Pat. No. 4,050,340 to Flanders, the drawings and summary clearly show that even though the track is designed to support both sides of the power tool, it is designed to guide only one side. Secondly, the first sentence of the first claim says that it requires a substructure. Thirdly, its straightness is limited to the straightness of its guide rails.

### OBJECTS AND ADVANTAGES

This invention approaches the problem of cutting large material from a unique direction. The ideal solution to working with large material has four basic needs:
1. there must be nothing attached to the power tool itself, so that the tool can be quickly dropped into the guide, used, and then taken off to do whatever other work is required
2. there must be no required substructure for the guide to attach to—it simply lies on the material itself, and, equally important, for cutting a hole in, for example, an existing floor, not require anything to necessarily extend below the material for the guide to work in most applications
3. in the preferred embodiment it can adjust and adapt to any number of tools, primarily circular saws and routers.
4. it must be very accurate, and make the power tools conform to that accuracy

The proposed power tool guide rail system is extremely simple. In the preferred embodiment, it would be composed of lightweight material, like aluminum extrusion, that would be quite thin in the vertical cross-section, for example ¼″-⅜″, and quite wide in the horizontal cross-section, for example 11″-12″, and long enough to accommodate large material like 4′×8′ sheets. The guide lies directly on the material being cut, and thus the material itself is providing the necessary vertical support—the guide is only required to provide lateral support. In the preferred embodiment, this lateral support would be provided mainly by the rigidity of the aluminum, but could also be aided by grip pads running lengthways along the bottom of the guide rail. These grip pads, in addition to aiding the lateral support for the guide would, for a great many applications (like ripping and crosscutting ¾″ thick sheet goods), provide all the necessary force to secure the guide in place during the cut, eliminating the need to lock it by another means.

The guide itself has a base component the bottom of which rests on the material and the top of which the power tools ride on, with a narrow, more or less central, through slot along the length of the base component for the blade or bit of the power tool to operate in. A left and right side rail, in the preferred embodiment, adjustably attach to the base component at several points along their lengths. The sides rails allow the guide to adapt to the different base plates of various power tools and keep them tracking straight along the length of the guide. The base component of the guide is designed so that it extends beyond the material at each end. It will, in the preferred embodiment, extend far enough that a circular saw, with the blade set to its maximum depth, can be sitting on the guide with the blade clear of the material at the start of the cut, and the base component will extend further than the blade and have enough width there to secure both sides of the base component that lie to the left and right of the central through slot. It will do essentially the same thing at the other end as well, although this requires less overhang because only the front teeth of the circular saw blade need to finish the cut.

To use the tool, one would first adjust the side rails to the power tool being used. In the case of a circular saw, by a simple process of measuring from the saw blade to the edge of the saw plate, one of the side rails on the guide can be adjusted to this measurement so that the blade will run near the center of the through slot in the base guide component. In the preferred embodiment, this side rail will be less substantial than the base component beneath it, and can therefore, with a known straight edge or string line, be further adjusted to true straight. The base plate of the power tool itself can then be tracked along and against the side rail just fixed and used to determine where to secure the second side rail so the tool slides easily but is well controlled.

In the preferred embodiment, the base guide will have a replaceable strip attached under the entire length of the through slot of the base component, that could be made out of something like neoprene or rubber. The first cut by the power tool will cut both the replaceable strip and the material being cut. For all subsequent cuts, the replaceable strip gives an exact read for, in the case of a circular saw, where both sides of the blade will cut. It will also provide a replaceable chip guard to reduce surface chipping on both sides of the material being cut.

The process of actually using the tool then becomes extremely simple. Mark the cut to be made on the material at two locations with a pencil and tape measure, lay the guide on the material so that the two pencil marks are aligned with either the left or right exposed edge of the replaceable strip that show where the blade cuts, and so there is enough clearance at the start of the cut for the saw blade to be free of the material, drop the saw into the guide so it is clear of the start of the cut, and proceed to do the cut. In the preferred embodiment, there could be a fixed or removable attachment for the side of the base guide component that provides a means for accurate repeat cuts.

### SUMMARY OF THE INVENTION

The proposed guide rail system is therefore a unique and powerful combination of these simple things—nothing attaches to the power tool itself, the guide guides both sides of the power tool, the guide requires no substructure, the guide adapts to a large variety of tools, the guide can be adjusted to true straight, and the guide is extremely lightweight and portable. Further objects and advantages will become apparent from a consideration of the ensuing description and drawings

### DETAILED DESCRIPTION OF THE INVENTION

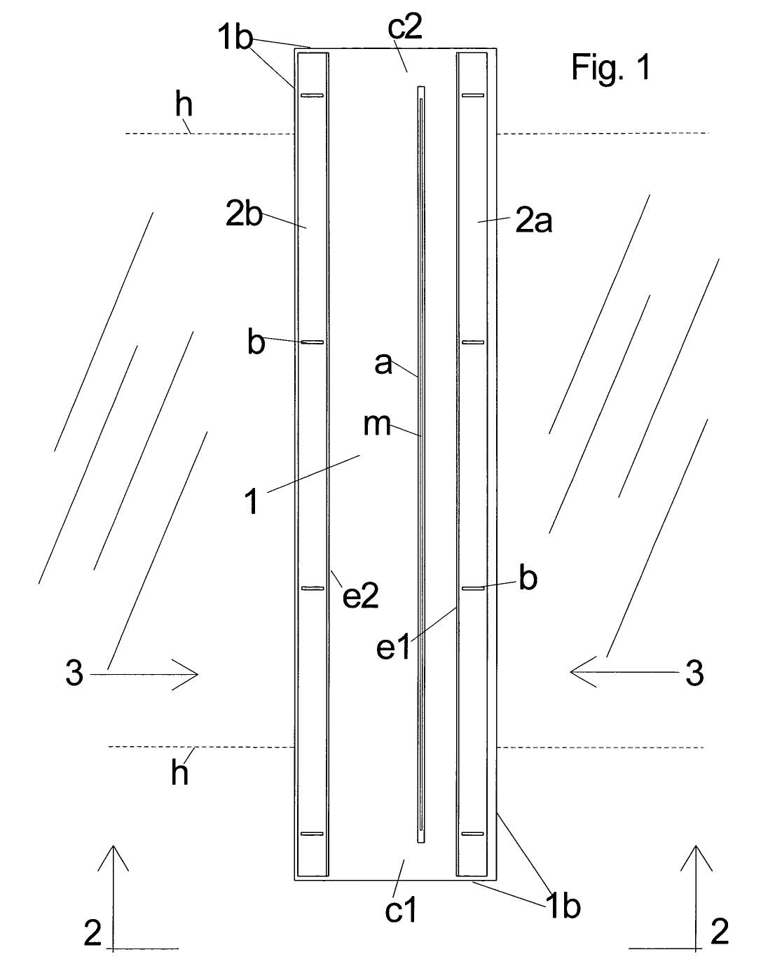

FIG. 1 shows the top view of the guide rail system

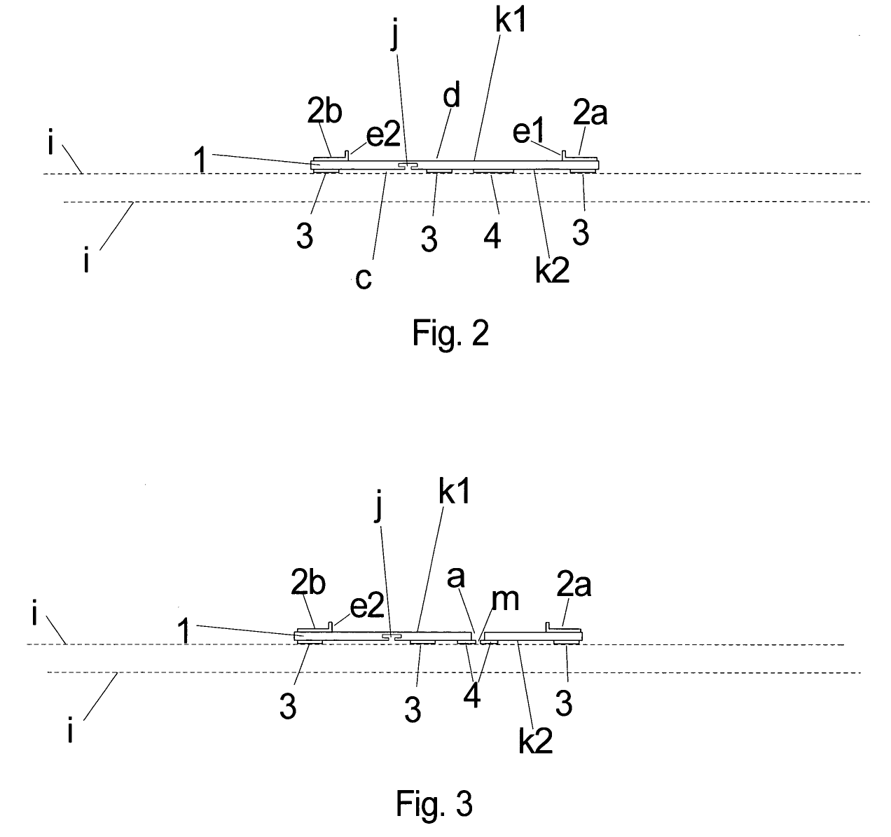

FIG. 2 shows the end plan view of the guide rail system

FIG. 3 shows the guide rail system in cross section

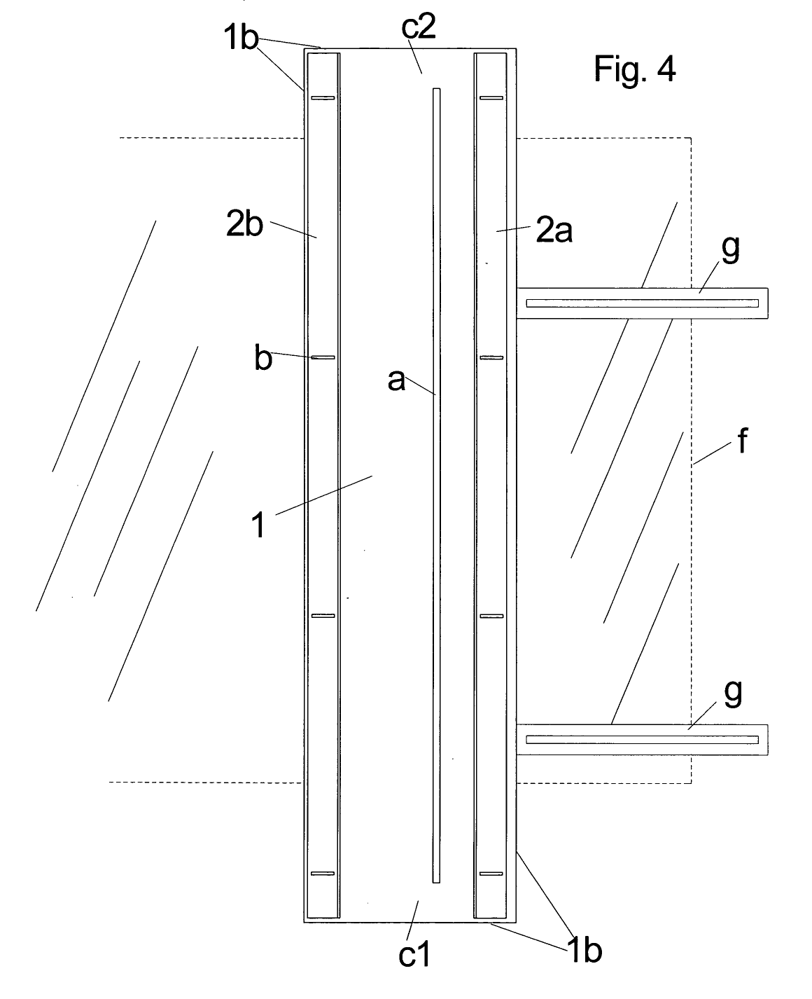

FIG. 4 shows the guide rail system in another embodiment, with side extensions providing means for referencing repeat cuts

A preferred embodiment of the guide rail system is shown in FIG. 1 (top view) and FIG. 2 (end view). In FIG. 1 we have a comprehensive view of the full tool from above. The dashed lines h represent the edges of the material to be cut, and the angled lines represent the material itself that lies between the dotted lines as seen from above. In FIG. 1, 1 is the base component of the rail system, and in the preferred embodiment is substantially flat when viewed from the end or side plan views. This base component is shown drawn at about 48″ long×about 11″ wide, although these dimensions are not critical and may be varied, but in general the length would be significantly greater than the width. This base component is designed, in the preferred embodiment, so that there are no moving or adjustable parts. This could be made out of a lightweight, strong material like aluminum. As shown in the drawing, in normal use the ends of the guide rail c1 and c2 will overhang the edges of the material h to allow the power tools room to enter and exit the cuts without cutting the guide rail itself. There is a through slot, a, either cut into the base component 1 or created by assembling the several pieces that could compose the base component 1. This slot is contained within the perimeter 1b of the base component 1, and runs longitudinally along it, more or less centrally located across the width. c1 and c2 represent the areas of the base component 1 that extends beyond the ends of the slot a. These areas support the base component to both sides of the slot and allows the base component 1 to function, in the preferred embodiment, essentially as a single unit. There are two guide components 2a and 2b attached to the base component 1. These guide components 2a and 2b in the preferred embodiment, will be less substantial than the base component 1 that they are attached to, and there are means, such as slots, b to adjust the guide components 2a and 2b laterally relative to the base component 1, allowing the guide components 2a and 2b to adjust to different tools and to true straight.

FIG. 2. is the end plan view of the invention. The dotted lines i are the material top and bottom seen from the end. This view would essentially be a mirror image at the other end. Note that nothing extends down from the guide rail below the surface of the material. Parts 3 and 4 are the only parts of the guide system, in the preferred embodiment, that sit lower than the bottom of the base component 1. In the preferred embodiment there are several grip strips 3 that attach to the bottom of the base component k2. These strips could be made out of foam or light rubber and because they sit slightly lower than the bottom of the base component k2, supply a surface friction with the material below it, giving the tool additional lateral rigidity and in many cases eliminating the need to lock the guide rail. Strip 4, in the preferred embodiment, would be replaceable and sit directly under slot a (not visible in this view but seen in FIG. 1 and FIG. 3), and could be made out of something cuttable but fairly stiff like neoprene of rubber, providing, when it is cut by a saw blade for example, a reference slot m (FIG. 1 and FIG. 3) to both sides of the saw blade's cutting width and also, because of its slight down pressure on the surface of the material, help prevent chipping of the material by the saw blade. The top of the base component k1 is what the power tools rest on and slide along and the vertical edges of the guide components 2a and 2b, marked e1 and e2, provide the necessary height to guide and contain the base of the power tools along the length of the guide components 2a and 2b. Slot j shows one embodiment of a means to connect an optional locking mechanism to the underside of the base component 1.

FIG. 3 shows the guide rail system in cross section. This view is similar to the view in FIG. 2 but slot m in strip 4 and slot a in base component 1 and where they locate are visible.

FIG. 4 shows the guide rail system form the top in a different embodiment, with two side extensions g, that sit on essentially the same horizontal plane as base component 1 and connect to base component 1 providing means to reference to the edge of the material f to allow the guide rail to do repeat identical cuts.

### OPERATION OF INVENTION

Before use, the two guide components 2a and 2b of the guide rail will be adjusted to the power tool being used. By measuring from the location of the power tool blade relative to the power tool base, the first guide rail 2a can be adjusted and locked to the base component 1 by using slots b so that the blade of the power tool will run at the center of slot a. The guide component 2a can be further adjusted with slots b to true straight if desired using a known straight edge or string line and locked there as well. The power tool itself is then rested on the top of the base component k1 and slid against e1 of the guide component 2a that is already attached. The vertical edge e2 of the second guide component 2b is then adjusted against the power tool base so that it is snugly controlled in longitudinal movement but slides easily. The guide rail is now ready to use.

The guide rail in its entirety is laid on the material to be cut, as shown in FIG. 1. The grip strips 3 on the bottom of the base component rest directly on the surface of the material providing friction for lateral support and locking. The first cut can be done in scrap material to establish the groove m in strip 4 that indicates the power tool's blade location. The location of subsequent cuts is determined by lining up one side or the other of groove m with measured marks on the material itself, or by using the side repeater referencing arms g shown in FIG. 4. The guide rail will extend over the material at the start end of the cut so that the power tool can be resting on the top of the base component k1, between the vertical edges of the two guide components e with its blade or bit in slot m ready to cut, and its blade or bit will be clear of the material and clear of c1 on the guide rail base component.

The power tool in use is then simply slid along between the two guide components 2a and 2b on top of base component 1—the guide rail will now automatically make the cut exactly straight.

### CONCLUSIONS, RAMIFICATIONS AND SCOPE

The reader will see that the proposed power tool guide system offers real advantages over existing tools: it allows precision beyond even its own inherent straightness, it requires no attachment to the power tool itself, making it very quick and easy to use, it can be aligned to work with many different tools, it gives a repeatable reference to future cuts and even offers means to do repeatable cuts, and it sits directly on the material, requiring no substructure of any kind.

While the above description contains many specificities, these should not be construed as limitations on the scope of the invention, but rather as an exemplification of one preferred embodiment thereof. Many other variations are possible, for example, a guide with fixed or integral side rails for a predetermined tool.

Accordingly, the scope of the invention should be determined not by the embodiment(s) illustrated, but by the appended claims and their legal equivalents.

I claim:

1. A guide rail system for hand held power tools, like circular saws and routers, designed to lay directly on the material to be worked, with no substructure of any kind, comprising:
a) a base component, the bottom of which substantially lies on the material, the top of which substantially supports the power tools, comprising one piece or a plurality of conjoined pieces, so that said base component is substantially a unit and lies on a substantially parallel horizontal plane to said material
b) said base component being of one length or a plurality of predetermined lengths to accommodate various lengths of said material, and of a width and rigidity to provide first means to substantially contribute to constraining the power tools accurately through said lengths
c) a longitudinally running through slot in said base component to provide second means for the power tools to operate through, said through slot to be contained a predetermined distance or distances within the perimeter of said base component
d) a plurality of guide components running longitudinally on both sides of said through slot and extending a predetermined distance substantially vertically from the top of said base component, said guide components providing third means to constrain the power tools to moving longitudinally in alignment with said through slot.

2. A guide rail system for hand held power tools, like circular saws and routers, designed to lay directly on the material to be worked, with no substructure of any kind, comprising:
a) a base component, the bottom of which substantially lies on the material, the top of which substantially supports the power tools, comprising one piece or a plurality of conjoined pieces, so that said base component is substantially a unit and lies on a substantially parallel horizontal plane to said material
b) said base component being of one length or a plurality of predetermined lengths to accommodate various lengths of said material, and of a width and rigidity to provide first means to substantially contribute to constraining the power tools accurately through said lengths
c) a longitudinally running through slot in said base component to provide second means for the power tools to operate through, said through slot to be contained a predetermined distance or distances within the perimeter of said base component
d) a plurality of separate guide components being attachable at a plurality of predetermined points to said base component, said separate guide components providing fourth means to adjust and secure said separate guide components across the width of said base component in a plurality of positions, said separate guide components, when attached, running longitudinally on both sides of said through slot and extending an adequate amount substantially vertically from the top of said base component, said separate guide components providing said third means to constrain the power tools to moving longitudinally in alignment with said through slot.

3. The guide rail system of claim 2 with said separate guide components being of adequately flexible construction such that said third means comprises adjusting said separate guide components at said plurality of predetermined points to true longitudinal straightness on said base component, even though said base component and said separate guide components themselves may not be inherently longitudinally straight.

4. The guide rail system of claim 1 with a replaceable, cuttable component attached above, within or under said through slot of said base component, each said replaceable component providing fourth means to locate and reference both sides of the individual power tool's cutting swath.

5. The guide rail system of claim 1 with a replaceable, cuttable component attached above, within or under said through slot of said base component, each said replaceable component providing fifth means to reduce surface chipping of said material to both sides of the individual power tool's cutting swath.

6. The guide rail system of claim 1 with grip pads attached within or underneath said base component, said grip pads to provide sixth means to provide additional lateral stability for said guide rail, and further, to secure said guide rail from movement during normal applications.

7. The guide rail system of claim 1 with said base component having an integral or separate sideways extension or a plurality of integral or separate sideways extensions, on substantially the same horizontal plane as said base component, said sideways extensions(s) to provide seventh means to reference said guide rail repeatably to a plurality of widths of cuts.

9. The guide rail system of claim 1 with said base component providing eighth means for a locking device to be attached within or underneath said base component, said locking device providing ninth means for securing said base component to said material.

10. A guide rail system for power tools, like circular saws and routers, comprising a method for:
a) lying directly on the material to be worked and requiring no substructure for the guide rail to function
b) straddling both sides of the power tools' longitudinal cutting swaths
c) constraining the power tools in a longitudinal operating direction with no attachments to nor special adaptations of the power tools being required.
